(19) United States
(12) Patent Application Publication
(10) Pub. No.: US 2019/0036120 A1
(43) Pub. Date: Jan. 31, 2019

(54) Amorphous LiF as an Artificial SEI Layer for Lithium Batteries

(71) Applicant: Robert Bosch GmbH, Stuttgart (DE)

(72) Inventors: Mordechai Kornbluth, Brighton, MA (US); Jonathan Mailoa, Cambridge, MA (US); Boris Kozinsky, Waban, MA (US); Georgy Samsonidze, Dorchester, MA (US); John F. Christensen, Elk Grove, CA (US)

(21) Appl. No.: 16/046,867

(22) Filed: Jul. 26, 2018

Related U.S. Application Data
(60) Provisional application No. 62/539,073, filed on Jul. 31, 2017.

(51) Int. Cl. H01M 4/58; H01M 4/136; H01M 10/0525

(52) U.S. Cl. CPC H01M 4/582; H01M 2300/008; H01M 10/0525; H01M 4/136

(57) ABSTRACT

A battery, in particular a Lithium-ion battery, includes a cathode, anode, and electrolyte. The cathode includes a first substrate with solid cathode material, and a first amorphous coating above the first substrate that acts as a first artificial solid-electrolyte interface (“SEI”) layer for the first substrate. The anode includes a second substrate with solid anode material, and a second amorphous coating above the second substrate that acts as a second artificial SEI layer for the second substrate. The electrolyte is disposed directly between the first and second amorphous coatings. A method of producing battery includes using low temperature atomic layer deposition processes to deposit material on first and second substrates, respectively, to form first and second amorphous coatings. The method further includes arranging an electrolyte directly between the first and second amorphous coatings in order to form a battery.

### RELATED APPLICATIONS

This application claims the benefit of priority to U.S. Provisional Application No. 62/539,073 filed on Jul. 31, 2017, entitled “Amorphous LiF as an Artificial SEI Layer for Lithium Batteries,” the entirety of which is incorporated by reference herein.

### TECHNICAL FIELD

This disclosure relates generally to batteries and, more particularly, to artificial solid-electrolyte interphase layers as a passivation coating for battery electrode materials.

### BACKGROUND

Lithium-based batteries have been widely incorporated for a variety of uses, from portable electronics to electric vehicles. A Lithium-ion battery (a “LiB”) is a battery in which lithium ions move through an electrolyte from a negative electrode (“anode”) to a positive electrode (“cathode”) during discharge. LiBs are generally rechargeable, whereby lithium ions migrate back from the cathode to the anode during charging.

Charging and discharging of a LiB can lead to unintended chemical side reactions occurring at the interfaces between the electrodes and the electrolyte. As a result, over their lifespan, LiBs tend to degrade progressively with reduced capacity, cycle life, and safety. Specifically, side reactions between battery materials, whether intended or inadvertent, can consume a portion of an electrode and result in the production of a solid-electrolyte interphase (“SEI”) layer at the interface between the electrode and the electrolyte. The composition of an SEI layer generally depends on the composition of the electrode and of the electrolyte.

In some instances, the material that forms an SEI on an electrode is a satisfactory ion conductor, and thus does not significantly inhibit the operation of the battery. In other instances, an SEI can be an ionic insulator that reduces or removes the ability of the battery to function. The consumption of battery materials due to formation of an SEI layer can also reduce the energy capacity of a LiB. SEI layers can also have other effects on the operation of a battery.

In some instances, the resulting SEI layer is an electronic insulator, whereby the side reactions will generally reach a steady state, and the SEI layer will substantially cease growing. In other instances, the SEI layer is electronically conductive, with the result that electron transport across the SEI feeds the side reactions, so that the SEI layer may continue to grow until the ultimate failure of the battery.

Successive or rapid charging and discharging of a LiB can also result in the formation of dendrites or filaments on one or more of the electrodes. A dendrite is a crystalline growth or buildup of material that can form along grain boundaries or other locations in a region of an interface between an electrode and an electrolyte. Filaments are tendrils of material which grow via crack propagation. Dendrites or filaments that ultimately grow to connect the anode and cathode can short-circuit the battery. Since the growth of dendrites or filaments is generally progressive over the lifespan of a LiB, dendrites and filaments represent a progressive risk for shorting a LiB. A shorted LiB can overheat, fail structurally or chemically, or present other safety concerns.

Various efforts have been made to form favorable and stable SEI layers and to inhibit dendrite and filament growth. In one example materials used to form the electrodes and/or electrolyte are limited to materials that would result in a favorable SEI. This may improve the safety or cycle life of the resulting battery, but generally results in the selection of sub-optimal materials from the perspective of energy density or efficiency. In another example with similar results, additive materials are included with the electrodes and/or the electrolyte in order to favorably change the composition of an SEI. Since the side reactions occurring at the electrode/electrolyte interface are complex, progressive, and not well understood in the art, these solutions have met limited success.

In a further example, passivation coatings have been used to form an artificial SEI on electrode material. As used herein an “artificial” SEI layer means a layer formed from deposited material rather than material consumed from other battery components. Coatings based on aluminum, titanium, lithium, and other materials have been coated onto electrodes, such as by electrochemical deposition, atomic layer deposition, and other acceptable processes. These coatings, however, generally exhibit sub-optimal material properties, such as low ionic conductance or low electrical resistance. Additionally, such coatings are generally not applicable to both an anode and a cathode, or do not satisfactorily inhibit dendrite and/or filament growth in the electrolyte.

In view of the foregoing, a passivation coating that can be applied to both anodes and cathodes would be beneficial. A coating that exhibits favorable SEI properties without limiting the materials used for electrodes and electrolytes would also be beneficial. A coating that inhibits dendrite and filament growth would also be beneficial.

### SUMMARY

Electrodes according to this disclosure include an amorphous artificial solid-electrolyte interface (“SEI”) layer, and can exhibit improved stability, efficiency, or longevity relative to conventional electrodes. An exemplary embodiment of an electrode according to this disclosure includes a substrate with solid electrode material, and an amorphous coating coated above a surface of the substrate. The amorphous coating acts as an artificial SEI layer for the substrate.

In some embodiments, the amorphous coating includes a passivated form of the solid electrode material of the substrate.

In some embodiments, the solid electrode material is a Li-metal based material, and the amorphous coating includes amorphous LiF.

In some embodiments, the electrode further includes an amorphous intermediate layer disposed between the substrate and the amorphous coating.

In some embodiments, the amorphous intermediate layer includes amorphous SiO₂.

In some embodiments, the amorphous coating has a thickness of less than 100 nm.

In some embodiments, the electrode is a cathode. In some embodiments, the solid electrode material of the substrate includes at least one of LFP, NCM, and NCA.

In some embodiments, the electrode is an anode. In some embodiments, the solid electrode material of the substrate includes at least one of Li-metal, silicon, graphite, and graphene.

Batteries according to this disclosure include electrodes with an artificial amorphous SEI layer, and can exhibit improved stability, efficiency, or longevity relative to conventional electrodes. An exemplary embodiment of a battery according to this disclosure includes a first electrode, a second electrode, and an electrolyte. The first electrode includes a first substrate with a first solid electrode material, and a first amorphous coating above a first surface of the first substrate. The first amorphous coating is configured to act as a first artificial SEI layer for the first substrate. The electrolyte is disposed directly between the first amorphous coating and the second electrode.

In some embodiments, the second electrode includes a second substrate with a second solid electrode material, and a second amorphous coating above a second surface of the second substrate. The second amorphous coating is configured to act as a second artificial SEI layer for the second substrate. The electrolyte is disposed directly between the first amorphous coating and the second amorphous coating.

In some embodiments, the first amorphous coating includes a first type of material, the second amorphous coating includes a second type of material, and the first type of material is the same as the second type of material.

In some embodiments, the first electrode is a cathode, the first solid electrode material is a solid cathode material, and the first amorphous coating includes a passivated form of the solid cathode material, the second electrode is an anode, the second solid electrode material is a solid anode material, and the second amorphous coating includes a passivated form of the solid anode material, and the electrolyte includes an electrolyte material.

In some embodiments, the first and the second amorphous coatings further include a passivated form of the electrolyte material, such that the battery is chemically stable. In some embodiments, the battery is, in particular, chemically stable during charging and discharging of the battery.

In some embodiments, the first electrode further includes a first amorphous intermediate layer disposed between the first substrate and the first amorphous coating.

In some embodiments, the second electrode further includes a second amorphous intermediate layer disposed between the second substrate and the second amorphous coating.

In some embodiments, the solid cathode electrode material is a Li-metal based material, the first amorphous coating includes amorphous LiF, the solid anode electrode material is a Li-metal based material, the first amorphous coating includes amorphous LiF, and the electrolyte is a fluorine-based material.

In some embodiments, the first electrode, the second electrode, and the electrolyte each consist of solid material.

An exemplary method of producing a battery according to this disclosure includes using a first low temperature atomic layer deposition (“ALD”) process to deposit first coating material in amorphous form above the first surface of the first substrate to form the first amorphous coating. The method further includes using a second low temperature ALD process to deposit second coating material in amorphous form above the second surface of the second substrate to form the second amorphous coating. The method additionally includes arranging the first substrate, the second substrate, and the electrolyte so that the electrolyte is directly between the first and second amorphous coatings in order to form the battery.

In some embodiments, the ALD processes in the method are performed at temperatures below 200° C.

In some embodiments, the ALD processes in the method are performed at atmospheric pressure.

In some embodiments, the method further includes, prior to performing the first ALD process, using a third ALD process to deposit first amorphous intermediate material above the first surface of the first substrate to form a first amorphous intermediate layer, such that the first ALD process deposits the first coating material directly on the first amorphous intermediate layer. The first amorphous intermediate layer acts as a base for the first coating material that promotes deposition of the first coating material in amorphous form. The method further includes, prior to performing the second ALD process, using a fourth ALD process to deposit second amorphous intermediate material above the second surface of the second substrate to form a second amorphous intermediate layer, such that the second ALD process deposits the second coating material directly on the second amorphous intermediate layer. The second amorphous intermediate layer acts as a base for the second coating material that promotes deposition of the second coating material in amorphous form.

### BRIEF DESCRIPTION OF THE DRAWINGS

FIG. 1 is a cross-section view of an exemplary embodiment of an electrode with an artificial SEI layer coating according to this disclosure.

FIG. 2 is a cross-section view of an exemplary embodiment of a battery according to this disclosure.

FIG. 3 is a cross-section view of another exemplary embodiment of an electrode with an artificial SEI layer coating according to this disclosure.

FIG. 4 is a cross-section view of another exemplary embodiment of a battery according to this disclosure.

FIGS. 5 and 6 are flow diagrams that depict different exemplary embodiments of methods of producing an electrode with an artificial SEI layer according to this disclosure.

FIGS. 7 and 8 are flow diagrams that depict different exemplary embodiments of method of producing a battery with electrodes having artificial SEI layers according to this disclosure.

FIG. 9 is a graph of kinetic temperature and potential energy over time during melting of a simulated sample of LiF.

FIG. 10 is a graph of MSD (the mean-squared displacement function) vs temperature for the simulated sample from FIG. 9.

FIG. 11 depicts graphs of RDF (the radial distribution function) vs temperature for the simulated sample of LiF of FIG. 9 quenched to different temperatures.

FIG. 12 is a graph of diffusivity of the simulated sample of LiF vs. temperature.

### DETAILED DESCRIPTION

For the purposes of promoting an understanding of the principles of the embodiments described herein, reference is now made to the drawings and descriptions in the following written specification. No limitation to the scope of the subject matter is intended by discussion of any individual embodiment. This disclosure also includes any alterations and modifications to the illustrated embodiments and includes further applications of the principles of the described embodiments as would normally occur to one skilled in the art to which this document pertains.

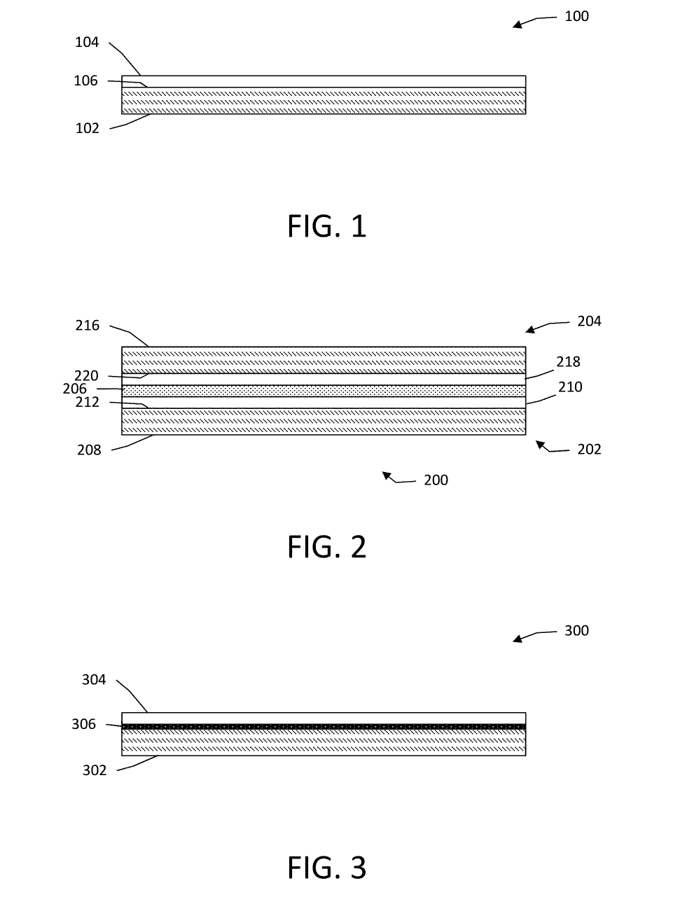

FIG. 1 depicts a plan view of an exemplary electrode 100 according to this disclosure. In some embodiments, the electrode 100 is an anode. In other embodiments, the electrode is a cathode. The electrode 100 includes a substrate 102 and an amorphous coating 104.

The substrate 102 is formed from any acceptable solid electrode material such as a material that includes at least one of lithium, silicon, carbon, aluminum, titanium, magnesium, tin, nickel, copper, iron, vanadium, cobalt, fluoride, phosphorous, and combinations or variants thereof. In some embodiments, the substrate 102 is embodied as an anode. An anode substrate 102, in different embodiments, includes any acceptable anode material such as Li-metal, silicon, graphite, graphene, etc., and combinations or variants thereof. In some embodiments, the substrate 102 is embodied as a cathode. A cathode substrate 102, in different embodiments, includes any acceptable cathode material such as LiFePO₄ (“LFP”), LiNiCoMnO₂ (“NCM”), LiNiCoAlO₂ (“NCA”), etc., and combinations or variants thereof. In various embodiments, the substrate 102 has any acceptable form, such as a foil, a solid block, a particulate material, a layered structure, or combinations thereof.

Lithium based materials, such as Li-metals for anodes and LFP for cathodes, have favorable properties in terms of high energy density and efficiency. In conventional LiBs, however, Li-metal based electrodes have several disadvantages, such as a tendency of the Li-metal to react with many types of electrolytes, leading to a steady degradation of charging capacity over the course of successive charge/discharge cycles. Li-metal based electrodes have also been found to be highly susceptible to dendrite and filament growth, which presents an increasing safety risk of a short over the lifetime of the LiB.

The coating 104 is coated onto a surface 106 of the substrate 102 so as to act as an artificial solid-electrolyte interface (“SEI”) layer. An artificial SEI layer coated onto the substrate 102 according to this disclosure, and in particular a Li-metal based substrate, can passivate the interaction between an electrolyte and the electrode 100 and can inhibit the formation and growth of dendrites and filaments. In some embodiments, the coating 104 consists of amorphous LiF. In other embodiments, the coating 104 consists of any acceptable amorphous material or combination of amorphous materials. Amorphous materials, including glassy materials, are characterized by short-range order with a lack of long-range order. In some embodiments, the amorphous coating 104 is substantially formed from amorphous materials, but additionally includes a relatively small amount of non-amorphous material such as, for example, impurities precipitated during formation of the coating 104, as discussed in further detail below.

An amorphous SEI layer according to this disclosure can exhibit improved ionic conductivity relative to the same materials in a more crystalline form. Further, an amorphous layer can be formed without grain boundaries that may otherwise promote dendrite and/or filament growth. In particular, amorphous LiF is an electronic insulator and ionic conductor, and can inhibit dendrite and filament growth when used as an SEI layer according to this disclosure to coat an electrode. Specifically, thin films of LiF have been found to have an ionic conductivity that is highly inversely correlated with the crystallinity of the structure. Amorphous LiF can be as much as four orders of magnitude more ionically conductive than crystalline LiF.

In some embodiments, the coating 104 has a thickness that is less than 100 nm. In some embodiments, the thickness is about 60 nm. Other thicknesses for the coating are also used in other embodiments.

FIG. 2 depicts an exemplary embodiment of a battery 200 according to this disclosure. The battery 200 includes an anode 202, a cathode 204, and an electrolyte 206 disposed therebetween.

The anode 202 includes a first substrate 208 and a first coating 210 coated onto a first surface 212 of the first substrate 208 facing toward the electrolyte 206 that acts as a first artificial SEI layer. The substrate 208 and first coating 210 are similar to the substrate 102 and coating 104 from FIG. 1.

The cathode 204 includes a second substrate 216 and a second coating 218 coated onto a second surface 220 of the second substrate 216 facing toward the electrolyte 206 that acts as a second artificial SEI layer. The substrate 216 and coating 218 are similar to the substrate 102 and coating 104 from FIG. 1.

In some embodiments, the coatings 210 and 218 each include a passivated form of materials present in the substrates 208 and 216 and in the electrolyte 206. In one such example, the anode 202 is lithium-based, such as a lithium-metal foil, the cathode 204 is lithium-based, such as LFP, the electrolyte 206 is a fluorine-based solid electrolyte, and the coatings 210 and 218 each include LiF. In other words, the coatings 210 and 218 each include a passivated form of the lithium and fluoride materials present in the substrates 208 and 216 and electrolyte 206. This correspondence of materials results in an artificial SEI layer that is chemically stable.

Other acceptable electrode, SEI layer, and electrolyte materials are also used in other embodiments. Additionally, in different embodiments, the electrolyte 206 is a solid, a polymer, a ceramic, a liquid, a gel, any other acceptable electrolyte material, or combination thereof.

FIG. 3 depicts another exemplary embodiment of an electrode 300 according to this disclosure. The electrode 300 includes a substrate 302, a coating 304, and an amorphous intermediate layer 306 disposed between the substrate 302 and the coating 304.

The substrate 302 and coating 304 are similar to the substrate 102 and coating 104 in FIG. 1. The amorphous intermediate layer 306 acts as a base to promote the amorphous formation of the coating 304 during deposition of the coating 104 via ALD, as discussed in further detail below. In some embodiments, the amorphous intermediate layer 306 includes amorphous SiO₂. In some embodiments, the amorphous intermediate layer 306 has a thickness of less than or equal to 3 nm. Amorphous intermediate layers with other amorphous materials and other thicknesses are also used in other embodiments.

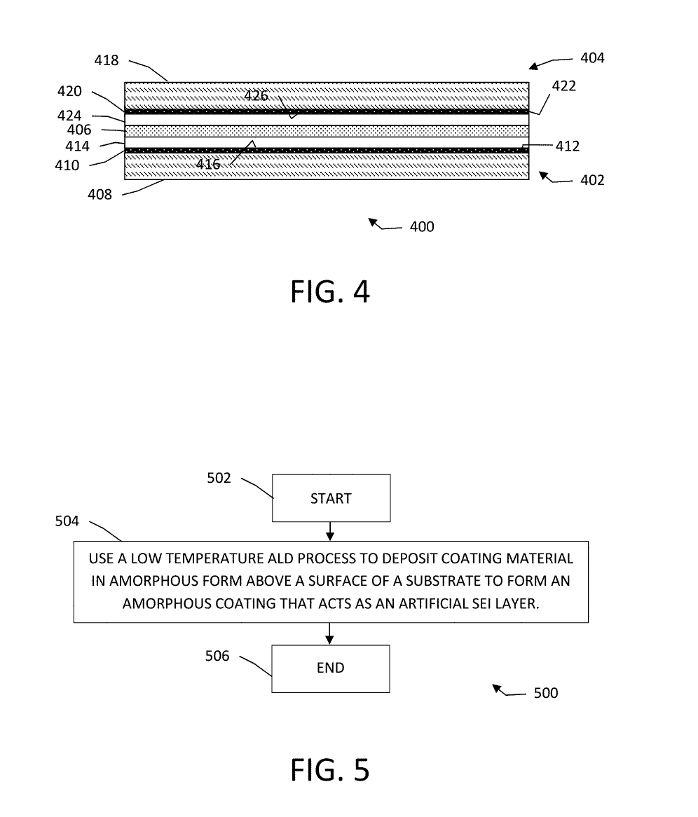

FIG. 4 depicts another exemplary embodiment of a battery 400 according to this disclosure. The battery 400 includes an anode 402, a cathode 404, and an electrolyte 406 that are similar to the anode 202, cathode 204, and electrolyte 206 in FIG. 2.

The electrolyte 406 is disposed between the anode 402 and cathode 404. The anode 402 includes a first substrate 408, a first amorphous intermediate layer 410 coated onto a surface 412 of the substrate 408 facing the electrolyte 406, and a first coating 414 coated onto a surface 416 of the intermediate layer 410 facing the electrolyte 406. The cathode 404 includes a second substrate 418, a second amorphous intermediate layer 420 coated onto a surface 422 of the substrate 418 facing the electrolyte 406, and a second coating 424 coated onto a surface 426 of the intermediate layer 420 facing the electrolyte 406.

An exemplary technique for forming layers or coatings according to this disclosure, such as the amorphous coatings and amorphous intermediate layers discussed above, includes depositing material via low temperature Atomic Layer Deposition. Atomic layer deposition (“ALD”) is a process whereby a coating or layer is formed via reactions between precursor gasses and a substrate. Precursor gasses are generally supplied via a pressure tank that is fed to a container housing the substrate. Generally, the substrate is held in a sealed container, and is exposed to one precursor gas at a time within the container for a period of time sufficient to enable the gas to chemisorb onto the substrate. The container is then purged of the gas, and a subsequent precursor gas is introduced. The newly supplied gas reacts with the previously chemisorbed material, resulting in the formation of a coating or layer above the surface of the substrate. Additional precursor gasses can be introduced along with corresponding purges between each stage of precursor gas. This process can be repeated in order to form coatings or layers of increasing thickness.

ALD is generally carried out at temperatures above 200° C., and more commonly at between 275-350° C., since performing ALD at lower temperatures has been found to result in impurities in the formed coating or layer, whereby unintended materials from the precursor gasses are present in the coating or layer after the precursor gasses have been purged from the system. The high temperature for ALD generally limits the materials that may be used for producing an electrode, since temperatures above 200° C. can degrade electrode laminates or otherwise damage at least a portion of the electrode. High temperature ALD also generally results in a highly crystalline coating or layer. Crystallinity generally results in grain boundaries, and can promote the growth of dendrites and/or filaments in a LiB over time.

Low temperature ALD according to this disclosure, and in particular low temperature ALD of LiF, has been found to significantly decrease the crystallinity of the resulting coating or layer. As used herein, low temperature ALD is defined as ALD performed at temperatures at or below 200° C. In some embodiments, low temperature ALD is performed at temperatures as low as 100° C., or as low as room temperature.

Low temperature ALD according to this disclosure results in a coating 104, 210, 218, 304, 414, 424 that is substantially amorphous and pinhole-free. While decreasing the deposition temperature when performing ALD has been known to increase an amount of impurities from the precursor gasses precipitating into the coating, it has been surprisingly found that the decrease in voltage stability that may result from impurities in the coating is minor compared to an increase in ionic conductivity resulting from the amorphous nature of the coating. Additionally, the amount of impurities that may be present in an artificial SEI layer resulting from low temperature ALD according to this disclosure is significantly decreased relative to naturally forming SEI layers formed from similar materials.

In some embodiments where the SEI layer formed by the coating 104 includes LiF, precursor gases used to form the coating 104 via low temperature ALD include Li(thd) (thd=2,2,6,6-tetramethylheptane-3,5-dionate) and TiF₄. In some embodiments, the precursor gasses further includes Mg(thd)₂. Other acceptable precursor gasses are also used in other embodiments.

In some embodiments, ALD is performed under pressure. In other words, the precursor gasses are stored under pressure, and the substrate is held under pressure in the container while exposed to the precursor gasses. The purge steps between each application of precursor gas can significantly extend the time needed to form the coating. Additionally, the need for holding the substrate under pressure increases the cost and complexity of machining needed to perform the ALD, and thus can limit the applicability of ALD in large scale manufacturing.

In some embodiments, low temperature ALD is performed at about atmospheric pressure, such that precursor gasses do not need to be stored under pressure, and the substrate does not need to be held under pressure during deposition. Operating at about atmospheric pressure can thus reduce cost, time, and complexity of the ALD process. In one example, the ALD is a Spatial Atmospheric Atomic Layer Deposition (“SAALD”) process. In a SAALD process, different precursor gasses are contained in separate chambers that are at atmospheric pressure. Rather than introducing gasses to a substrate along with interlaced purge steps, the substrate is moved from chamber to chamber in order to be exposed to each precursor gas. In one example of a SAALD process, inert gas curtains are used to separate different precursors. Since a SAALD process does not require interlaced purge steps, the time needed to form the coating is drastically decreased. Further, since the SAALD process operates at atmospheric pressure, machining costs and complexity relative to conventional ALD are significantly reduced.

FIG. 5 depicts an exemplary method 500 for producing an electrode according to this disclosure. In some embodiments, the electrode is a cathode. In some embodiments, the electrode is an anode. The method starts at block 502, and at block 504, a low temperature ALD process is used to deposit coating material in amorphous form above a surface of the substrate to form an amorphous coating that acts as an artificial SEI layer for the electrode. The method ends at block 506.

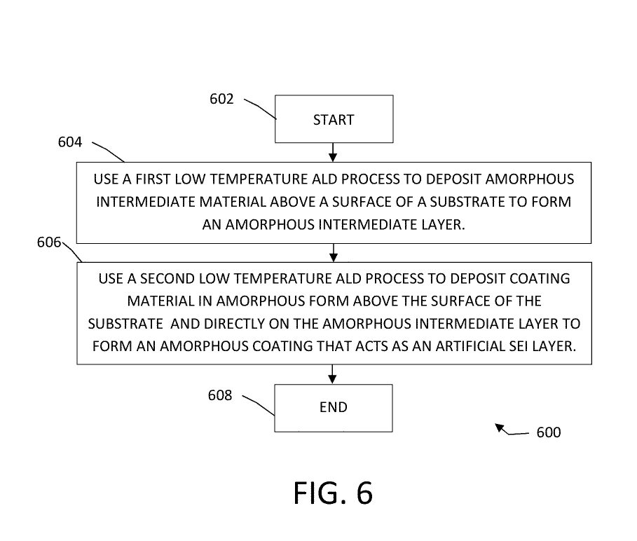

FIG. 6 depicts another exemplary method 600 for producing an electrode according to this disclosure. In some embodiments, the electrode is a cathode. In some embodiments, the electrode is an anode. The method starts at block 602, and at 604, a first low temperature ALD process is used to deposit amorphous intermediate material above a surface of a substrate to form an amorphous intermediate layer. At block 606, a second low temperature ALD process is used to deposit coating material in amorphous form above the surface of the substrate, directly onto the amorphous intermediate layer to form an amorphous coating that acts as an artificial SEI layer for the electrode.

Deposition of a coating onto an amorphous surface induces the coating to precipitate in amorphous form during deposition via ALD. Thus, the intermediate amorphous layer can increase the amorphousness of the coating in order to increase ionic conductivity without increasing the presence of impurities. In other words, the intermediate layer acts as a base for the coating material, whereby the amorphous form of the intermediate layer promotes deposition of the coating material in amorphous form. The method ends at block 608.

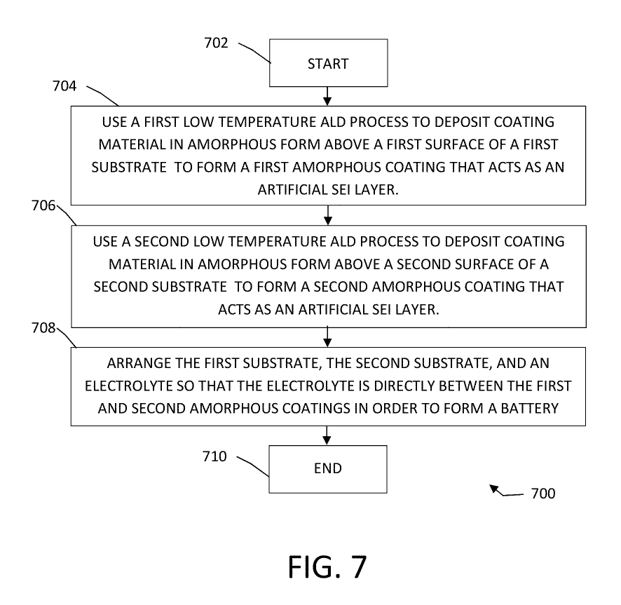

FIG. 7 depicts an exemplary method 700 for producing a battery according to this disclosure. The method starts at block 702, and at block 704 a first low temperature ALD process is used to deposit first coating material in amorphous form above a first surface of a first substrate to form a first amorphous coating. At block 706, a second low temperature ALD process is used to deposit second coating material in amorphous form above a second surface of a second substrate to form a second amorphous coating. At block 708, the first substrate, the second substrate, and an electrolyte are arranged so that the electrolyte is directly between the first and second amorphous coatings in order to form the battery. The method ends at block 710.

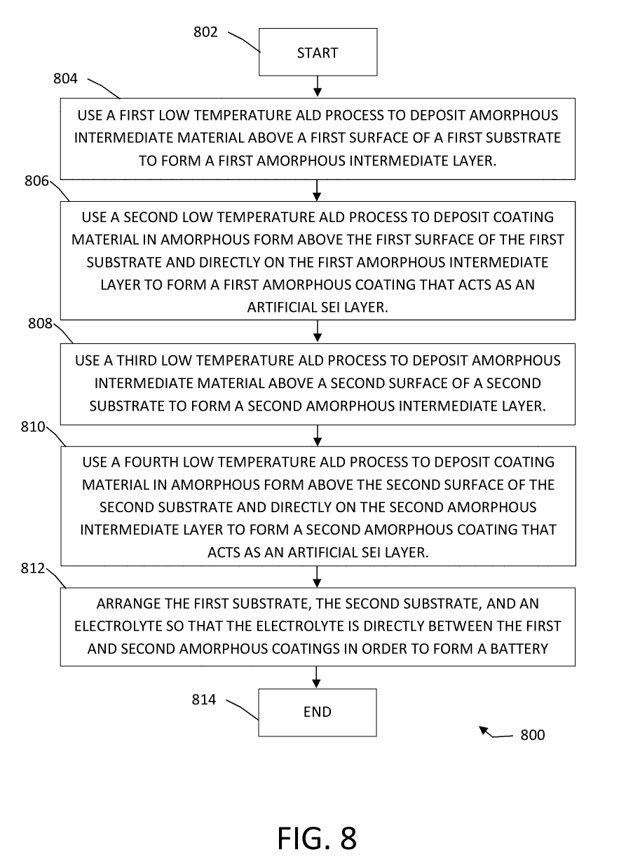

FIG. 8 depicts an exemplary method 800 for producing a battery according to this disclosure. The method starts at block 802, and at block 804 a first low temperature ALD process is used to deposit amorphous intermediate material above a first surface of a first substrate that includes solid cathode material to form a first amorphous intermediate layer. At block 806, a second low temperature ALD process is used to deposit first coating material in amorphous form above the first surface of the first substrate and directly onto the first amorphous intermediate layer to form a first amorphous coating. The first amorphous coating acts as an artificial SEI layer for the first substrate and, together with the first substrate, forms a cathode.

At block 808, a third low temperature ALD process is used to deposit amorphous intermediate material above a second surface of a second substrate that includes solid anode material to form a second amorphous intermediate layer. At block 810, a fourth low temperature ALD process is used to deposit second coating material in amorphous form above the second surface of the second substrate and directly onto the second amorphous intermediate layer to form a second amorphous coating. The second amorphous coating acts as an artificial SEI layer for the second substrate and, together with the second substrate, forms a cathode. At block 812, the first substrate, the second substrate, and an electrolyte are arranged together so that the electrolyte is directly between the first and second amorphous coatings in order to form the battery. The method ends at block 814.

The feasibility of amorphous coatings as an artificial SEI layer was verified via experimental simulation for amorphous LiF. Examination was performed using classical molecular dynamics using a Buckingham potential with an explicit Coulomb term. A 6×6×6 supercell (1728 atoms) was constructed for simulation with a lfs (1×10⁻¹⁵ second) time step. All simulations were performed with an NPT ensemble (constant-pressure) in atmospheric pressure. The following steps were performed via simulation.

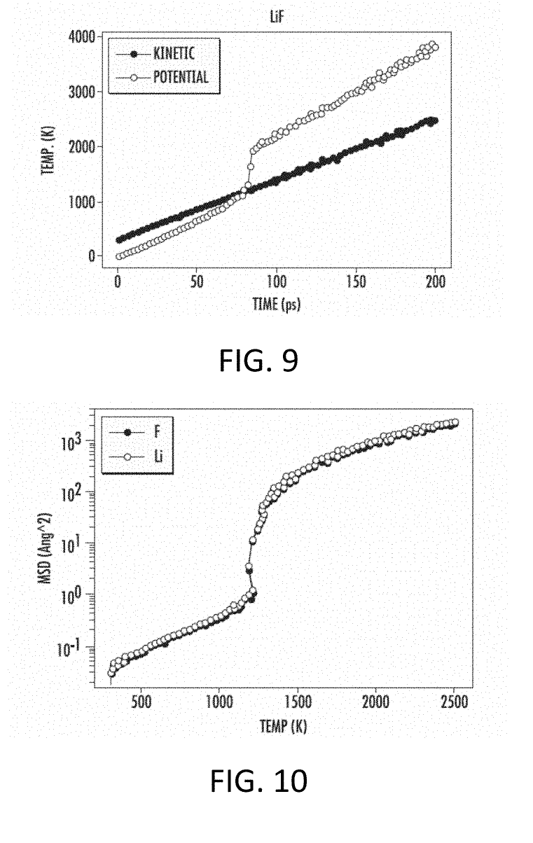

The supercell structure was melted via heating from 300K to 2500K over 200 ps (rate: 11K/ps). FIG. 9 depicts a graph of the kinetic temperature and potential energy of the supercell over time during the heating. The potential energy jump once kinetic temperature reaches 1200K illustrates a melting phase transition.

Snapshots of the supercell were taken every 10 ps (10×10⁻¹² second) mark during the heating. The snapshots were then used to perform molecular dynamics. Specifically, each snapshot was used to simulate a rapid quench of the melted material from the respective snapshot temperature to each of 300K, 600K, and 900K. By rapidly quenching the supercell, the structure of the supercell at the snapshot temperature was preserved, whether amorphous or crystalline. From each snapshot, the radial distribution function (“RDF”) and mean-squared displacement (“MSD”) were extracted.

MSD describes diffusivity (MSD divided by time is proportional to diffusivity). FIG. 10 depicts a graph of MSD at varying temperatures of the molecular-dynamics simulation. The increase in the MSD at the temperature of 1200K illustrates an increase in mobility associated with a transition from a solid phase to a liquid phase.

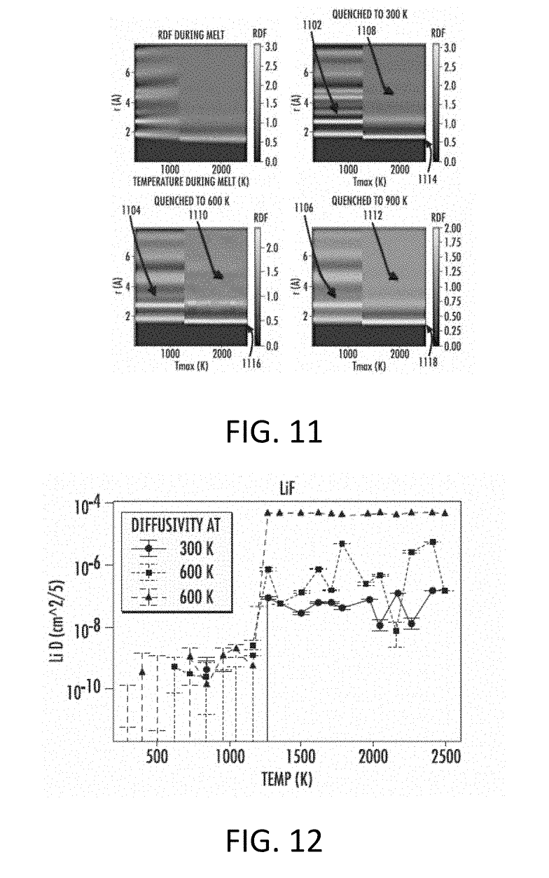

RDF describes glassiness (lack of long-range order) and is indicative of the probability function of two atoms being separated by a particular distance r. FIG. 11 depicts the RDF during the heating (leftmost panel), and after a melt-quench cycle with the melt temperature of T_max (horizontal axis) and the quench temperature of 300, 600, or 900 K (respectively for the three rightmost panels), with the RDF measured during the quench portion. As illustrated in FIG. 11, upon quenching, the solid phase (T_max<1200K) recovers its crystalline structure, evidenced by the sharp peaks in the RDF spectrum (1102, 1104, 1106). However, the liquid phase (T_max>1200K) forms a glass, shown by the lack of long-range peaks in the RDF (1108, 1110, 1112). The short-range peaks (1114, 1116, 1118) describe a solid with Li—F bonds at an approximately fixed bond length.

FIG. 12 depicts a graph of diffusivity as a function of melt and quench temperature. The melt-quench cycle has a melt temperature of T_max (horizontal axis) and the quench temperature of 300, 600, or 900 K (datasets), with the diffusivity measured during the quench portion. As illustrated in FIG. 12, the diffusivity increases as the quench (simulation) temperature increases during the glassy phase. When the structure melted and formed its glassy state (T_max>1200K), the Li diffusivity, and hence conductivity, jumps by a few orders of magnitude. In other words, the amorphous form of the material exhibited improved properties relative to the solid phase of the same material.

While the above embodiments have been described with reference to LiBs, the reader should appreciate that the above-described coating is not limited to LiBs. The coating is suitable for passivating a wide variety of electrodes such as, for example an electrode in a lithium-air battery, a fuel cell, and other energy storage devices.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the foregoing disclosure.

1. An electrode, comprising:
a substrate including a solid electrode material; and
an amorphous coating above a surface of the substrate, the amorphous coating configured to act as an artificial solid-electrolyte interface (“SEI”) layer for the substrate.

2. The electrode of claim 1, wherein the amorphous coating includes a passivated form of the solid electrode material of the substrate.

3. The electrode of claim 1, wherein the solid electrode material is a Li-metal based material, and the amorphous coating includes amorphous LiF.

4. The electrode of claim 1, further comprising:
an amorphous intermediate layer disposed between the substrate and the amorphous coating.

5. The electrode of claim 4, wherein the amorphous intermediate layer includes amorphous SiO₂.

6. The electrode of claim 1, wherein the amorphous coating has a thickness of less than 100 nm.

7. The electrode of claim 1, wherein the electrode is a cathode, and the solid electrode material of the substrate includes at least one of LFP, NCM, and NCA.

8. The electrode of claim 1, wherein the electrode is an anode, and the solid electrode material of the substrate includes at least one of Li-metal, silicon, graphite, and graphene.

9. A battery, comprising:
a first electrode, including:
a first substrate having a first solid electrode material; and
a first amorphous coating above a first surface of the first substrate, the first amorphous coating configured to act as an artificial solid-electrolyte interface (“SEI”) layer for the first substrate;
a second electrode; and
an electrolyte disposed directly between the first amorphous coating and the second electrode.

10. The battery of claim 9, wherein:
the second electrode includes:
a second substrate having a second solid electrode material; and
a second amorphous coating above a second surface of the second substrate, the second amorphous coating configured to act as an artificial SEI layer for the second substrate; and
the electrode is disposed directly between the first amorphous coating and the second amorphous coating.

11. The battery of claim 10, wherein:
the first amorphous coating includes a first type of material;
the second amorphous coating includes a second type of material; and
the first type of material is the same as the second type of material.

12. The battery of claim 10, wherein:
the first electrode is a cathode, the first solid electrode material is a solid cathode material, and the first amorphous coating includes a passivated form of the solid cathode material;
the second electrode is an anode, the second solid electrode material is a solid anode material, and the second amorphous coating includes a passivated form of the solid anode material;
the electrolyte includes an electrolyte material; and
the first and the second amorphous coatings further include a passivated form of the electrolyte material, such that the battery is chemically stable.

13. The battery of claim 12, wherein:
the first electrode further includes a first amorphous intermediate layer disposed between the first substrate and the first amorphous coating; and
the second electrode further includes a second amorphous intermediate layer disposed between the second substrate and the second amorphous coating.

14. The battery of claim 12, wherein:
the solid cathode electrode material is a Li-metal based material;
the first amorphous coating includes amorphous LiF;
the solid anode electrode material is a Li-metal based material;
the second amorphous coating includes amorphous LiF; and
the electrolyte material is a fluorine-based material.

15. The battery of claim 9, wherein:
the first electrode further includes a first amorphous intermediate layer disposed between the first substrate and the first amorphous coating.

16. The battery of claim 9, wherein the first electrode, second electrode, and electrolyte each consist of solid material.

17. A method of producing a battery, comprising:
using a first low temperature atomic layer deposition (“ALD”) process to deposit a first coating material in amorphous form above a first surface of a first substrate to form a first amorphous coating;
using a second low temperature ALD process to deposit a second coating material in amorphous form over a second surface of a second substrate to form a second amorphous coating; and
arranging the first substrate, the second substrate, and an electrolyte so that the electrolyte is directly between the first and second amorphous coatings in order to form a battery.

18. The method of claim 17, wherein the ALD processes are performed at temperatures below 200° C.

19. The method of claim 17, wherein the ALD processes are performed at atmospheric pressure.

20. The method of claim 17, further comprising:
prior to performing the first ALD process, using a third ALD process to deposit a first amorphous intermediate material above the first surface of the first substrate to form a first amorphous intermediate layer, such that the first ALD process deposits the first coating material directly on the first amorphous intermediate layer, wherein the first amorphous intermediate layer acts as a base for the first coating material that promotes deposition of the first coating material in amorphous form; and
prior to performing the second ALD process, using a fourth ALD process to deposit a second amorphous intermediate material above the second surface of the second substrate to form a second amorphous intermediate layer, such that the second ALD process deposits the second coating material directly on the second amorphous intermediate layer, wherein the second amorphous intermediate layer acts as a base for the second coating material that promotes deposition of the second coating material in amorphous form.
